(19) United States
(12) Patent Application Publication
(10) Pub. No.: US 2014/0272336 A1
(43) Pub. Date: Sep. 18, 2014

(54) BOUND DOCUMENT WITH TRANSPARENT OVERLAY SHEET

(71) Applicants: Cheryl Lenhard, Rochester, NY (US); Richard Salter, Rochester, NY (US); Steven J. Tomanovich, Rush, NY (US)

(72) Inventors: Cheryl Lenhard, Rochester, NY (US); Richard Salter, Rochester, NY (US); Steven J. Tomanovich, Rush, NY (US)

(21) Appl. No.: 13/803,370

(22) Filed: Mar. 14, 2013

(51) Int. Cl. B44C 1/10

(52) U.S. Cl. CPC B44C 1/10
USPC 428/203

(57) ABSTRACT

A bound document including a non-transparent image sheet having at least one printed image formed by printing a digital image file and an overlay sheet bearing an overlay image. The image sheet and the overlay sheet are bound together in respective spine areas thereof, so that the image sheet can be viewed either directly or through the overlay sheet, the printed image being at least partially visible through the overlay sheet. The overlay image includes at least some image content that is the same as corresponding image content in the printed image, the image sheet and overlay sheet being bound so that the image content in the overlay image is substantially in register with the corresponding image content in the printed image.

### CROSS-REFERENCE TO RELATED APPLICATIONS

Reference is made to commonly assigned, co-pending U.S. patent application Ser. No. ______ (Docket K001291), entitled: “Bound document with transparent metadata sheet”, by Lenhard et al., which is incorporated herein by reference.

### FIELD OF THE INVENTION

This invention pertains to the field of producing photo books and more particularly to a photo book that includes a transparent overlay sheet that overlays an image sheet.

### BACKGROUND OF THE INVENTION

In recent years, the proliferation of digital photography has provided consumers with a variety of options to store and use captured images. These options include various “soft copy” methods involving memory cards, memory sticks, CD's, DVD's, hard drives, on-line storage etc. These “soft-copy” options, while providing the environmental benefit of eliminating the paper, ink or dye, and other chemicals required for “hard-copy” output, are potentially less secure for long term storage due to media format obsolescence, storage media physical or chemical breakdown, and on-line storage companies disappearing. A variety of options exist for customers to print digital images, including conventional silver halide processing, ink-jet, thermal dye transfer, and electrophotographic methods. These “hard-copy” methods are capable of providing printed output which can last for many decades. Although customers can make such “hard-copy” prints at home, modern retail outlets provide kiosks and order-terminals where both prints and additional services can be requested and provided. Similar services are also available from on-line companies such as Shutterfly.

An increasingly popular service provides photo albums or photo books with collections of images associated with a specific event, such as a vacation, family gathering, school function etc. The photo books are composed of printed images produced by any one of a wide variety of printing methodologies that are bound together in book form. The photo books can be custom made at retail stores or at centralized facilities.

A wide variety of metadata is often associated with digital images, such as filenames, capture dates, camera settings, geographical locations, event types and names of persons pictured in the images. Traditionally, many of these pieces of information would be recorded on the back of a printed photograph, either automatically when the image was printed or manually by the user, to provide a context for the photograph. When producing a photo book it is generally not practical to print such information on the back of the printed image since the book pages are typically double sided. One alternative is to provide the metadata in the form of text (e.g., captions) printed adjacent to the images, or directly onto the images. Adding text directly onto the printed image can adulterate the original image and attenuate the ensuing emotional response. Even captions added adjacent to the printed images can be distracting to the aesthetic appeal of the printed page, particularly when mundane information such as the filename and camera settings is included in the caption. In some cases, adding titles, quotes, celebratory greetings, poetry and other textual content/embellishments can enhance the appeal of the printed page, but even then it would still be desirable in many cases to be able to view the image without the added modifications.

U.S. Pat. No. 5,022,682 to Desmond, entitled “Book with transparent pages with mirrored images on front and back,” discloses a book that includes one or more transparent sheets inserted between pages of opaque stock. The transparent sheets have images reproduced on both sides of the sheet, affording the viewer one basic image that has two different views to enable illustrations on the opaque pages to be altered without losing sight of the original pages.

U.S. Pat. No. 5,181,745 to Jacobsen et al., entitled “Printed image creating the perception of depth,” discloses a printed image that provides an illusion of depth comprising a multilayer transparent laminate structure. The layers in the laminate structure each have a portion of the image, where the portion of the image perceived to be most distant from the viewer is located on the back layer, and the portion of the image perceived to be closest to the viewer is located on the front layer.

U.S. Pat. No. 5,560,799 to Jacobsen, entitled “In-line printing production of three dimensional image products incorporating lenticular transparent material,” discloses a method for producing a printed image creating an illusion of depth. The method includes printing an image on an opaque web that is positioned behind a transparent web having a lenticular surface on one side.

U.S. Pat. No. 6,979,487 to Scarbrough et al., entitled “Glossy printed article and method of manufacturing same,” discloses a printed article including a reflective layer printed on the top surface of a substrate. A graphic design layer is printed on the reflective layer. A textured pattern of transparent ink and a glossy layer is printed over the graphic design layer.

There remains a need for a way to include metadata in a photo book in a manner that does not detract from the aesthetic quality of the printed images.

### SUMMARY OF THE INVENTION

The present invention represents a bound document including:

a non-transparent image sheet having at least one image side bearing a printed image; and

an overlay sheet bearing an overlay image, the overlay image including at least some image content that is the same as corresponding image content in the printed image;

wherein the image sheet and the overlay sheet are bound together in respective spine areas thereof, so that the image sheet can be viewed either directly or through the overlay sheet such that the printed image is at least partially visible through the overlay sheet, the image content in the overlay image being substantially in register with the corresponding image content in the printed image.

This invention has the advantage that the overlay image can provide visual effects that can enhance the aesthetic appearance of the printed image. Optionally, metadata content can be included on the overlay image to label the images in a photo book using metadata associated with the printed images without detracting from the aesthetic appearance of the photo book pages.

It has the additional advantage that a three-dimensional appearance can be provided by printing the overlay image on a thick transparent substrate.

### BRIEF DESCRIPTION OF THE DRAWINGS

FIG. 1 illustrates a bound document including an image sheet and an overlay sheet with textual content;

FIG. 2 shows an exploded side view of the bound document of FIG. 1;

FIG. 3 illustrates a bound document including an image sheet and an overlay sheet with textual content and an embellishment;

FIG. 4 illustrates a bound document including an image sheet and an overlay sheet with textual content and semi-transparent image content;

FIG. 5 illustrates a bound document including an image sheet and an overlay sheet with textual content and outline image content; and

FIGS. 6-7 illustrate two photo book variations having front covers that include a transparent window with an overlay image which overlays a printed image on the first page of the book.

It is to be understood that the attached drawings are for purposes of illustrating the concepts of the invention and may not be to scale.

### DETAILED DESCRIPTION OF THE INVENTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The present invention will now be described with reference to the attached drawings. FIG. 1 illustrates a bound document 140 according to an exemplary embodiment of the present invention. The bound document 140 includes a non-transparent image sheet 100 bearing at least one printed image 110 on an image side, and an overlay sheet 120 with textual content 130 provided on a transparent substrate. The image sheet 100 and the overlay sheet 120 are bound together in respective spine areas 150 to forming a bound edge 160, so that the image sheet 100 can be viewed either directly or through the overlay sheet 120 where the printed image 110 is at least partially visible through the overlay sheet 120. In the illustrated example, the bound edge 160 is the left edge of the bound document 140. However, this is not limiting. One skilled in the art will recognize that the spine areas 150 could be along any edge of the bound document 140 (e.g, the right edge, the top edge or the bottom edge). FIG. 2 shows an exploded side view of the bound document of FIG. 1, showing the alignment of the spine areas 150 of the image sheet 100 and the overlay sheet 120 along the bound edge 160.

In some embodiments, the image sheet 100 has an opaque substrate on which the printed images 110 are formed. In other embodiments, the image sheet 100 can have a semi-transparent substrate. Within the context of the present disclosure, an opaque substrate is one in which an image positioned behind the substrate is not visible through the substrate. Conversely, a transparent substrate is one that permits an image positioned behind the substrate to be clearly viewed through the substrate. A semi-transparent substrate is one that permits an image positioned behind the substrate to be viewed through the substrate with some degree of distortion. Some semi-transparent substrates can include a color or gray tint that absorbs a portion of the light transmitted through the substrate, while others can include light scattering elements that partially blurs light transmitted through the substrate. Non-transparent substrates include substrates which are opaque or semi-transparent.

The printed images 110 are formed by printing digital image files using any appropriate printing technology. In a preferred embodiment, the digital image file stores an image captured using a digital camera. In other embodiments, the digital image file can be provided using other image sources. For example, the digital image file can store an image provided by scanning a hardcopy image using a digital scanner, or can store a computer generated image formed using any appropriate software application known in the art.

The digital image files have associated metadata providing information pertaining to the corresponding digital images. In some embodiments, the metadata is provided by the digital camera used to capture the digital image file and is stored as header information within the digital image file. In other embodiments, the metadata can be stored in a database or a separate data file associated with the digital image file.

The overlay sheet 120 provides textual content 130 on a transparent substrate. In some exemplary embodiments, the transparent substrate is an acetate or polyester transparency media, but any appropriate transparent material known in the art can be used in accordance with the present invention. Typical thicknesses of the transparent substrate would be between 4-13 mil.

In the embodiment of FIG. 1, the overlay sheet 120 bears a metadata image that contains metadata content extracted from the metadata associated with the digital image file corresponding to the printed images 110. In the illustrated example, the metadata content is represented as metadata text printed as textual content 130.

The textual content 130 can include a variety of different types of metadata content. In some embodiments, the textual content can include text indicating a capture date (and optionally the capture time) that the digital image file was captured. The capture date is commonly specified in metadata included in the digital image file. The capture date/time can be represented in any appropriate format (e.g., “Jun. 1, 2012”, “6/1/12” or “06/01/12, 11:15 AM”).

Many cameras (e.g., smart phones) include a global positioning system (GPS) sensor that records GPS metadata providing an indication of a geographical location where the digital image file was captured (e.g., longitude and latitude values). The textual string can represent the geographical location in various formats. For example, a textual string can be used to specify the latitude and longitude. In some embodiments, the GPS metadata can be used to access a geographical database to determine a textual string corresponding to the geographical location. The textual string representing the geographical location can include a town/city name (e.g., “Estes Park, Colo.”), an address corresponding to the geographical location (e.g., “152 Main St.”), a general geographic region (e.g., “Rocky Mountains”), or a name of a specific park, a tourist attraction or a venue corresponding to the geographical location (e.g., “Rocky Mountain National Park”).

In some embodiments, the textual content 130 can include text indicating a file name of the digital image file. This can be useful for locating a particular digital image file that was printed to create the printed image 110. The textual content can also include text indicating one or more camera settings used to capture the digital image file (e.g., an exposure time, an F/# or a flash mode). Many photographers find it useful to record such information with their photographs.

In some embodiments, the textual content includes text pertaining to the semantic content of the printed image 110. For example, the text pertaining to the semantic content can provide an indication of an event type of the scene depicted in the printed image 110 (e.g., “wedding”, “graduation”, “birthday”, “family vacation”, “family reunion” or “picnic”). In some cases, the event type can be determined by automatically analyzing the digital image file using any event classification algorithm known in the art. For example, U.S. Patent Application 2009/0297032 by Loui et al., entitled “Semantic event detection for digital content records,” which is incorporated herein by reference, teaches a method for semantic event classification. This method utilizes visual features in the images to semantically classify the images. In other cases, the event type can be manually specified by a user using an appropriate user interface.

The text pertaining to the semantic content can also provide an indication of the identity of at least one person or object depicted in the printed image 110. In some embodiments, the identity of the depicted persons can be determined by using an appropriately-trained face recognition algorithm to automatically analyze the digital image file. In other cases, the identity of the depicted persons can be manually specified by a user using an appropriate user interface (e.g., using a “tagging” process such as that used in the well-known Facebook application). Similarly, depicted objects (e.g., “dog” or “car”) can be identified using an automatic object recognition algorithm, or using a manual user interface.

The exemplary textual content 130 includes a combination of text strings representing a plurality of different types of metadata content. Namely, text providing an indication of the identity of a depicted person (e.g., “Mike”), text providing an indication of a geographic location (e.g., “Rocky Mountains”) and text indicating the image capture date (e.g., “6/1/12”).

In some embodiments, the textual content 130 can include a caption manually specified by a user using an appropriate user interface. In some cases, the digital image file can be a Facebook image tagged with a Facebook comment. The Facebook comment can be used as a caption that can be included in the textual content 130.

Preferably, the textual content 130 is printed in alignment with the corresponding printed image 110. In the exemplary embodiment of FIG. 1, the metadata content (i.e., the textual content 130) is positioned so that it is adjacent to the corresponding printed image 110 when the image sheet 100 is viewed through the overlay sheet 120. In this case, the textual content 130 is below the corresponding printed image 110. In other embodiments, the textual content 130 can be above or to the side of the corresponding printed image 110, or can be placed in multiple locations.

FIG. 3 illustrates another example of a bound document 140 including an image sheet 100 and an overlay sheet 120 that includes a number of different text fields (i.e., textual content 132, 134, 136) associated with each of the printed images 110. Some of the text fields (i.e., textual content 132, 134) are positioned so that they overlay the corresponding printed image 110 when the image sheet 100 is viewed through the overlay sheet 120, while other text fields (i.e., textual content 136) are positioned so that they are adjacent to the corresponding printed image 110 when the image sheet 100 is viewed through the overlay sheet 120. Textual content 132 is a text string indicating a geographical location and a capture date; textual content 134 is a text string providing an indication of the identity of a depicted person in the associated printed image 110; and textual content 136 is a text string indicating a file name, and camera settings (i.e., an F/# and an exposure time) for the associated printed image 110.

In this example, some of the metadata content (i.e., the textual content 134 providing an indication of the identity of a depicted person) corresponds to a particular portion of the corresponding printed image 110 (i.e., the location of the depicted person). This textual content 134 is printed in alignment with the corresponding portions of the printed image 110 so that the name of the depicted person overlays the depicted person when the image sheet 100 is viewed through the overlay sheet 120. This can be particularly useful for images containing a plurality of depicted persons so that it is clear which name corresponds to which person.

The overlay sheet 120 can optionally include additional content that is not extracted from the metadata associated with the digital image file. For example, the overlay sheet 120 can include one or more graphical elements such as embellishment 138. In some cases, the embellishment 138 can be selected and positioned by a user using an appropriate user interface. In other cases, the embellishment 138 can be automatically selected in accordance with the metadata (e.g., an embellishment 138 depicting a lobster can be selected for printed images 110 having a geographical location corresponding to the Maine seashore, or an embellishment 138 depicting confetti can be selected for printed images 110 captured at midnight on New Year's Eve, or an embellishment 138 depicting a party hat can be selected for printed images 110 captured at a birthday party event).

In some embodiments, the overlay sheet 120 can include at least some image content that is the same as the corresponding image content in the printed image 110 as illustrated in FIG. 4. In this example, the overlay sheet 120 includes overlay images 170 that are semi-transparent renditions of the corresponding printed images 110. The overlay images 170 are positioned such that when image sheet 100 and the overlay sheet 120 are bound together in their respective spine areas 150 to form the bound document 140, the image content in the overlay images 170 is substantially in register with the corresponding image content in the printed images 110.

When the image sheet 100 is viewed through the overlay sheet 120, the printed images 110 are at least partially visible through the overlay images 170 on the overlay sheet 120. The resulting overlaid images 175 will generally have a darker appearance than the printed images 110 have when they are viewed directly. This approach has the advantage that the textual content 134 on the overlay sheet is placed in context with the image content of the overlay images 170, even when the overlay sheet 120 is viewed without being overlaid on the image sheet 100.

The textual content 132, 134 and overlay images 170 can be printed on either side of the overlay sheet 120. If they are printed on the back surface of the overlay sheet 120 that faces the image sheet 100, they should generally be printed in a reverse orientation such that they will have a proper orientation when viewed from through the front surface of the overlay sheet 120.

In some embodiments, the overlay sheet 120 includes a first overlay image 180 printed on a first side of the overlay sheet 120 (e.g., the side that faces away from the image sheet 100) and a second overlay image 180 printed on an opposing second side of the overlay sheet 120 (e.g., the side that faces toward the image sheet 100) substantially in register with the first overlay image. The first and second overlay images 180 can have the same or different image content. This can provide a higher density level for the resulting overlaid images 175. Depending on the thickness of the overlay sheet 120, the overlay images 170 printed on the side of the overlay sheet 120 that faces away from the image sheet 100 can appear to be raised above the printed images 110, providing a 3-D effect. If any content is printed on the back surface of the overlay sheet 120 that faces the image sheet 100, it should generally be printed in a reverse orientation such that it will have a proper orientation when viewed from through the front surface of the overlay sheet 120.

In some embodiments, the image content in the overlay images 170 can include only a portion of the image content of the printed images 110. For example, the overlay images 170 can include semi-transparent renditions of the people depicted in the printed images 110, but can be fully transparent for portions of the image content corresponding to the background regions in the printed images 110.

FIG. 5 illustrates a variation of the approach shown in FIG. 4. In this case, the image content in the overlay images 180 is an outline image corresponding to edges in the image content in the printed images 110. The outline images can be created using any appropriate image processing algorithm known in the art. Such methods generally involve computing derivatives or gradients of the image content. Often secondary operations (e.g., thresholding, linking and thinning) are applied to form cleaner edge images. In some embodiments, the outline images are formed by applying the well-known Canny edge detection algorithm to the image content in the printed images 110.

As with the embodiment described relative to FIG. 4, the overlay images 180 are positioned such that when image sheet 100 and the overlay sheet 120 are bound together in their respective spine areas 150 to form the bound document 140, the image content in the overlay images 180 is substantially in register with the corresponding image content in the printed images 110. The edges in the resulting overlaid images 185 will generally have a darker appearance than the printed images 110 have when they are viewed directly. This approach shares the same advantage that the textual content 134 on the overlay sheet is placed in context with the image content of the overlay images 180, even when the overlay sheet 120 is viewed without being overlaid on the image sheet 100. However, the overlaid images 185 will not have the darker appearance characteristic of the FIG. 4 approach. Some users may prefer the darker appearance of the overlaid images 175 of FIG. 4, while others may prefer the enhanced edges of the overlaid images 185 of FIG. 5.

In an exemplary embodiment, the bound document 140 is a photo book, and the image sheet 100 and overlay sheet 120 are consecutive pages in the photo book. In some implementations, the photo book can contain a plurality of image sheets 100, each of which is bound consecutively with a corresponding overlay sheet 120. For cases where the pages of the photo book are double-sided and include printed images 110 on both sides of the image sheets 100, two overlay sheets 120 can be provided, one overlay sheet 120 bound before the image sheet including metadata content relevant to the front side of the image sheet 100, and a second overlay sheet 120 bound after the image sheet 100 including metadata content relevant to the back side of the image sheet 100. Alternately, the bound document 140 can be any other type of document having a plurality of pages known in the art (e.g., a magazine, a pamphlet, a calendar or a greeting card).

In some embodiments, photo books can be produced where the width of the overlay sheets 120 are slightly less than (or slightly greater than) the width of the corresponding image sheets 100. In this way, when a user turns a page, the narrower sheets will turn together with wider sheets. In this way, if the pages are turned in one direction (e.g., from back-to-front) the overlay sheets 120 will be overlaid over the corresponding image sheets 100, but if they are turned in the other direction (e.g., from front-to-back) the image sheets 100 can be viewed directly.

FIG. 6 illustrates an exemplary embodiment of a bound document 260 having a front cover 220 and a back cover 225 bound together with a plurality of image sheets 200 with spine 250. In this case, a first image sheet 205 including a printed image 210 serves the role of the image sheet (e.g., see FIG. 4) and a transparent window 230 in the front cover 220 serves the role of the overlay sheet 120 (e.g., see FIG. 4). In some embodiments, the transparent window 230 can be fabricated using a stiff transparent material such as Plexiglas or some other type of plastic or glass. The thickness T of the transparent material can be adjusted to provide a desired degree of stiffness. Typical thicknesses would be between 0.5-10 mm.

The transparent window 230 includes content (i.e., an overlay image 240 or textual content 245 or both) that correspond to the printed image 210 on first image sheet 205. The overlay image 240 and the textual content 245 can be determined using any of the methods that were described above with respect to FIGS. 1-5. In some embodiments, the textual content 245 can include a book title for the photo book that is relevant to the printed images in the photo book (e.g., “Maine Vacation 2012”). The overlay image 240 and the textual content 245 can be printed on either side of the transparent window 230. In the illustrated embodiment, the overlay image 240 and the textual content 245 are printed on the front side of the transparent window 230 that faces away from the first image sheet 205. In this case, the thickness T of the transparent material (e.g., 2 mm) can provide a three-dimensional appearance when the printed image 210 on the first image sheet 205 is viewed through the overlay image 240 and the textual content 245 on the transparent window 230.

While FIG. 6 illustrates an embodiment where the overlay content is provided on the front cover 220 of the bound document 260, it will be obvious to one skilled in the art that the same approach could equivalently be used for the back cover 225, or even for an intermediate page.

FIG. 7 shows a similar embodiment where the overlay image 240 and the textual content 245 are inserted between a front transparent window 232 and a back transparent window 234. The overlay image 240 and the textual content 245 can either be printed on the back surface of the front transparent window 232 or on the front surface of the back transparent window 234. Alternately, they can be printed on a thin transparent substrate that is sandwiched between the front transparent window 232 and the back transparent window 234.

The approach shown in FIG. 7 has a number of advantages relative to that shown in FIG. 6. First, the front transparent window 232 protects the overlay image 240 and the textual content 245 from damage (e.g., scratching). Additionally, this approach provides independent control of the total thickness of the transparent window (the sum of the thicknesses of the front transparent window 232 and the back transparent window 234) and the magnitude of the three-dimensional fact (which will be controlled by thicknesses of the back transparent window 234).

The invention has been described in detail with particular reference to certain preferred embodiments thereof, but it will be understood that variations and modifications can be effected within the spirit and scope of the invention.

### PARTS LIST

100 image sheet
110 printed image
120 overlay sheet
130 textual content
132 textual content
134 textual content
136 textual content
138 embellishment
140 bound document
150 spine area
160 bound edge
170 overlay image
175 overlaid image
180 overlay image
185 overlaid image
200 image sheet
205 first image sheet
210 printed image
220 front cover
225 back cover
230 transparent window
232 front transparent window
234 back transparent window
240 overlay image
245 textual content
250 spine
260 bound document
T thickness

1. A bound document including:
a non-transparent image sheet having at least one image side bearing a printed image; and
an overlay sheet bearing an overlay image, the overlay image including at least some image content that is the same as corresponding image content in the printed image;
wherein the image sheet and the overlay sheet are bound together in respective spine areas thereof, so that the image sheet can be viewed either directly or through the overlay sheet such that the printed image is at least partially visible through the overlay sheet, the image content in the overlay image being substantially in register with the corresponding image content in the printed image.

2. The bound document of claim 1 wherein the image content in the overlay image is a semi-transparent rendition of the corresponding image content in the printed image.

3. The bound document of claim 1 wherein the image content in the overlay image is an outline image corresponding to edges in the image content in the printed image.

4. The bound document of claim 1 wherein the overlay image further includes textual content or an embellishment.

5. The bound document of claim 4 wherein the printed image is formed by printing a digital image file, and wherein the textual content includes text indicating a date or a geographical location that the digital image file was captured, text indicating a file name of the digital image file or text indicating one or more camera settings used to capture the digital image file.

6. The bound document of claim 5 wherein GPS metadata associated with the digital image file provides an indication of a geographical location where the digital image file was captured, and wherein the text indicating the geographical location is determined by accessing a geographical database using the GPS metadata.

7. The bound document of claim 4 wherein the textual content includes text pertaining to the semantic content of the printed image.

8. The bound document of claim 7 wherein the printed image is formed by printing a digital image file, and wherein the text pertaining to the semantic content includes text identifying an event at which the digital image file was captured.

9. The bound document of claim 7 wherein the text pertaining to the semantic content includes at least one text label identifying a person or object depicted in the printed image.

10. The bound document of claim 4 wherein the textual content includes a caption provided by a user.

11. The bound document of claim 4 wherein at least some the textual content includes portion-specific textual content that corresponds to particular portions of the printed image, and wherein the portion-specific textual content is printed in alignment with the corresponding portions of the printed image.

12. The bound document of claim 1 wherein the overlay sheet has a back surface that faces the image sheet and an opposing front surface that faces away from the image sheet, and wherein the overlay image is printed on the back surface of the overlay sheet, the overlay image being printed in a reverse orientation such that it has a proper orientation when viewed from through the front surface of the overlay sheet.

13. The bound document of claim 1 wherein the overlay sheet includes a first overlay image printed on a first side of the overlay sheet and a second overlay image printed on an opposing second side of the overlay sheet substantially in register with the first overlay image.

14. The bound document of claim 12 wherein the first and second overlay images include the same image content.

15. The bound document of claim 12 wherein the second overlay image is printed in a reverse orientation such that it has a proper orientation when viewed through the front surface of the overlay sheet.

16. The bound document of claim 1 wherein the overlay sheet serves as a cover of the bound document.

17. The bound document of claim 1 wherein the overlay sheet has a back surface that faces the image sheet, an opposing front surface that faces away from the image sheet and a thickness of more than 0.5 mm, and wherein the overlay image is printed on the front surface of the overlay sheet to provide a three-dimensional appearance when the image sheet is viewed through the overlay sheet.
